(19) United States
(12) Patent Application Publication
(10) Pub. No.: US 2005/0288839 A1
(43) Pub. Date: Dec. 29, 2005

(54) Method for steering a vehicle and device for procedure the method

(76) Inventors: Egon Auer, Bregenz (AT); Horst Krimmel, Tettnang (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/157,249

(22) Filed: Jun. 21, 2005

(30) Foreign Application Priority Data
Jun. 29, 2004 (DE) 10 2004 031 259.1

(51) Int. Cl. B62D 5/04

(52) U.S. Cl. 701/41; 180/443

(57) ABSTRACT

A method for steering a vehicle, whereby a steering wheel, a steering wheel angle δ_{LR} and a steering control based on it, a radii angle δ_{RL} and a steering angle gradient ω_{RL} are generated. The steering angle gradient ω_{RL} is limited by a reliable, admissible value ω_{ZUL} which can be calculated based on the driving situation.

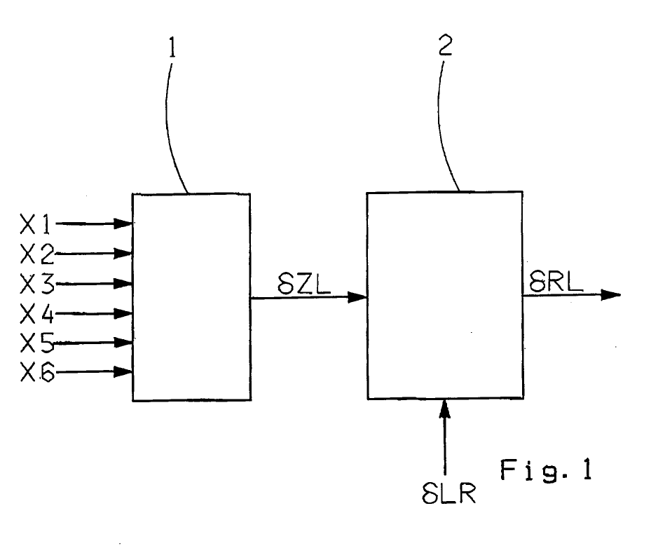

The invention relates to steering a motor vehicle according to preamble to patent claim 1 and a device for implementing the process.

Known steering systems regulate the dynamic of the motor vehicle movement by engagement of the steering whereby, depending on an admissible rate of yaw, a counteracting steering movement to an undesirable yaw movement takes place. Such steering systems with the so called yaw rate regulators have been known from the DE-A 101 41 274, as well as DE-A 197 51 227. This yaw rate regulation has been undertaken especially in the case of a condition in which the motor vehicle malfunctions, for example, it would be used during braking in a driving lane with different rates of friction for the right and for the left side of the vehicle (so called μ-split roadway) or in the case of occurrence of a side winds.

A process and a device for regulating the motor vehicle movement dynamic is known from DE-A 102 12 582 whereby, taking account of a target yaw dynamic, a steering angle servo control value is established, which is then used for a steering intervention.

A process for operating a steering system is know from DE-A 102 18 579, which uses a superposition transmission (AFS=active front steering) with a sub input into which an additional steering angle is entered which has been determined in a drive dynamic computer.

In certain driving situations, e.g., during a “pull” of the steering by the motor vehicle driver, the known yaw rate regulators fail. Such a driving situation, e.g., a motor vehicle under steering, can occur when the driver (especially an inexperienced driver) has a tendency to steer further into the line of sight in order to, as he thinks, force the vehicle into a measured response. In the case of a strong steering of the wheels into the line of sight, the transferable lateral tire forces on the highway become smaller since the characteristic curve of the physically transferable tire transverse action beyond a maximum for radii angle drops off; insofar as the continued steering into the line of sight no longer contributes to the yaw rate. Furthermore, this so called over-steering of the front wheels briefly reduces the tire transverse action and thus the yaw rate of the vehicle will be briefly reduced which, in terms of the motor vehicle movement dynamic, becomes destabilizing.

The invention is based upon the objective of making such a critical driving situation controllable and thus increasing the safety of the vehicle.

The solution to this problem follows from the features of patent claim 1. According to the invention, the aforementioned process for controlling the steering angle gradient will be limited. That is to say, the changes in the locking of the wheel of the vehicle may not exceed an admissible value. The excessive pull of the steering wheel and the loss of the track of the vehicle will thereby be avoided. That is to say, in case of an over-steering with a steering wheel, the tires will retain a sufficient frictional connection with the roadway so that the vehicle will continue to be steerable. The buildup of a dangerous floating angle can thus be early and directly affected. Overall, it results in the advantage of a greater steering safety of the vehicle.

In a further advantageous refinement of the invention, the admissible steering angle gradient in the respective driving situation will be calculated in dependence of various parameters, e.g., as a function of the steering wheel angle of speed (steering wheel angle gradient), the steering wheel angle, the radii angle, tire friction values and on vehicular longitudinal speed. Taking these parameters into consideration will provide a realistic marginal value for calculating the steering angle gradient (change in the radii angle). This means that the static friction between the tires and the roadway will be maintained as long as possible, especially in under steering driving situations, i.e., up to the margins of physical possibilities.

In another advantageous refinement of the invention, the radii angle (in brief referred to as a steering angle) a supplemental steering angle, which is calculated in dependence on the earlier calculated reliable steering angle gradient, will be overridden by the steering control. This supplemental angle is, by over steering with the steering wheel, an additional negative angle, which reduces the actual steering angle to the permissible standard.

The objective of the invention will also be accomplished through a device to carry out the process, according to the invention, specifically through an active front steering designed as a planetary gear system which provides for a variable steering reduction ratio. Such active front steering is known under the designation of “active steering” from a prospectus of the ZF Steering Systems GmbH Co. and is also run in series as “active steering” by a German automobile maker. A similar active front steering (AFS) is also known from DE-A 102 18 579 and as planetary gear system with variable steering ratio from DE-C 43 26 355. With such a planetary gear system, it is advantageous that a supplemental steering angle of the invention can be entered through a second input shaft by way of an electro motor and be superimposed onto the steering wheel angle entered into the first input shaft. Thus, the mechanical link between the steering wheel and the wheels is retained and that represents a safety factor for the steering.

The problem of the invention will also be solved through the steering system in which a supplemental angle is hydraulically superimposed upon the steering wheel angle. Here, also, the mechanical linkage between the steering wheel and the wheels is retained. The supplemental steering angle, however, will not be entered in over a mechanical active front steering, but over a purely hydraulic arrangement.

In a further advantageous refinement of the invention, the steering wheel control can also be developed as a so called “steer by wire” system. With that, there will not be any mechanical link between the steering wheel and the wheels. The steering wheel commands are exclusively transmitted electrically (by wire). According to the invention, the supplemental steering angle will thus be subtracted from the steering wheel angle in a control unit.

The only FIGURE represents the process according to the invention in a schematic display. Various parameters x1, x2, x3, x4, x5 and x6 of the steering system (not represented here in greater detail) will be entered and processed in the computer 1. The significance of the parameters is as follows:
x1: Steering wheel angle speed ω_{LR}
x2: Steering wheel angle δ_{LR}
x3: Radii angle δ_{RL}
x4: Tire friction values η_{R}
x5: Vehicle longitudinal speed (V_{X}) and
x6: Vehicle stability reserve.

The dependency of the named parameters x1 to x6 will be the upper limit for the steering angle gradient ω_{RL}. i.e., a maxim admissible value, which will be determined in a computer unit 1. This upper limit value of the steering angle gradient, i.e., of the angle speed with which the wheels will be locked, represents a quasi ideal way the margins between the road grip and the sliding friction of the wheels on the roadway. Depending upon these upper limits of the steering angle gradient ω_{RL}, supplemental steering angle δ_{ZL} will be determined and issued, which will be supplied to a superposition steering unit 2 or entered. The superposition steering unit 2, for example, is a known planetary gear system with two input and one output shafts, which make a variable control ratio possible between the steering wheel angle δ_{LR} and the radii angle δ_{RL}. Such active front steering became know through a ZF Steering Systems Co. prospectus under the designation of ZF active steering for the middle and upper class type personnel vehicles and is currently being mass produced in vehicles of the German automobile manufacturers. While the driver-selected steering wheel angle δ_{LR} is entered through the first input shaft (not represented), the supplemental steering angle δ_{ZL} will be entered through a second input shaft (not represented) into the active front steering 2. The radii angle δ_{RL} (also referred to as the steering angle) is transmitted through a second output shaft (not represented here) of the active front steering 2. This steering angle δ_{RL} is thus adjusted to the driving situation and prevents the break out (gliding angle buildup) of a vehicle in an over steering mode.

The active front steering 2 represents a mechanical linkage between the not represented, steering wheel and the not represented, wheels of the motor vehicle and thus creates a mechanical redundancy.

Nevertheless, it is also possible to superposition the supplemental steering angle by means of a “steer by wire” system. The supplemental steering angle δ_{ZL} will thus not enter into the “steer by wire” system mechanically but as an electrical signal.

### REFERENCE NUMERALS

1 computer
2 active front steering (AFS)
δ_{LR} steering wheel angle
ω_{LR} steering wheel angle gradient or, as the case may be, angle speed
δ_{RL} radii angle (steering angle)
ω_{RL} steering angle gradient or, as the case may be, angle speed
ω_{ZUL} permissible value for a steering angle gradient supplemental steering angle
δ_{ZL} supplemental steering angle
V_{X} vehicle longitudinal speed (in x direction)
μ_{R} friction value tires/roadway

1-7. (canceled)

8. A method for steering a motor vehicle, comprising the steps of entering a steering wheel angle δ_{LR} of a steering wheel and then, by means of a steering control, generating a radii angle δ_{RL} and a steering angle gradient ω_{RL}, with the steering angle gradient ω_{RL} being limited by a permissible value ω_{ZUL}, which can be calculated.

9. The method according to claim 8, further comprising the step of calculating the permissible value ω_{ZUL} depending on the following parameters: steering wheel angle speed ω_{LR}, steering wheel angle δ_{LR}, radii angle δ_{RL}, the friction value between tires and a roadway μ_{R}, and a vehicle longitudinal speed V_{X}.

10. The method according to claim 8, further comprising the step of overriding the radii angle δ_{RL} by the steering control unit-calculated, and a supplemental steering angle δ_{ZL} depending on the steering angle gradient ω_{ZUL}.

11. The method according to claim 10, further comprising the step of overriding the radii angle δ_{LR} by a negative supplemental steering angle δ_{ZL}.

12. The method according to claim 8, wherein the steering control has an active front steering (2) with variable steering reduction rate and two entry shafts through each of which the steering wheel angle δ_{LR} and the supplemental steering angle δ_{ZL} can be entered.

13. A device for carrying out a method for steering a motor vehicle, comprising the steps of entering a steering wheel angle δ_{LR} of a steering wheel and then, by means of a steering control, generating a radii angle δ_{RL} and a steering angle gradient ω_{RL} with the steering angle gradient ω_{RL} being limited by a permissible value ω_{ZUL}, which can be calculated;
wherein the steering control has a hydraulic arrangement over which each of the steering wheel angle δ_{LR} and the supplemental steering angle δ_{ZL} can be entered.

14. The device for carrying out the method according to claim 8, wherein the steering control is a “steer by wire” system.

15. A method for steering a motor vehicle comprising the steps of:
entering a steering wheel angle δ_{LR} of a steering wheel into a steering control,
generating a radii angle δ_{RL} and a steering angle gradient ω_{RL} in the steering control; and
limiting the steering angle gradient ω_{RL} by a permissible value ω_{ZUL} which can be calculated.

16. The method according to claim 15, further comprising the step of calculating permissible a value ω_{ZUL} depending on at least one of the following: a steering wheel angle speed ω_{LR}, a steering wheel angle δ_{LR}, a radii angle δ_{RL}, a friction value between tires and a roadway μ_{R}, and a vehicle longitudinal speed V_{X}.

17. The method according to claim 15, further comprising the step of overriding the radii angle δ_{RL} by the steering control unit calculated supplemental steering angle δ_{ZL} depending on the steering angle gradient ω_{ZUL}.

18. The method according to claim 17, further comprising the step of overriding the radii angle δ_{LR} by a negative supplemental steering angle δ_{ZL}.

19. The method according to claim 15, further comprising the step of entering the steering wheel angle δ_{LR} and the supplemental steering angle δ_{ZL} through two entry shafts to the steering control which has an active front steering (2) with a variable steering reduction rate.
